(19) United States
(12) Patent Application Publication
(10) Pub. No.: US 2006/0293012 A1
(43) Pub. Date: Dec. 28, 2006

(54) TERRESTIAL DIGITAL MULTIMEDIA BROADCASTING RECEIVER

(75) Inventors: BYEONG HAK JO, SUWON (KR); WON JIN BAEK, EUIWANG (KR); JEONG KI CHOI, SUWON (KR); KYUNG SEOK PARK, SUWON (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/422,060

(22) Filed: Jun. 2, 2006

(30) Foreign Application Priority Data
Jun. 22, 2005 (KR) 10-2005-53957

(51) Int. Cl. H04B 1/06

(52) U.S. Cl. 455/264; 370/312; 455/323

(57) ABSTRACT

The present invention relates to a terrestrial DMB receiver capable of eliminating image noise and minimizing the number of external elements. In the invention, a terrestrial DMB signal is down-converted into a baseband I/Q signal and then up-converted into a predetermined intermediate frequency signal. The invention solves the problematic image noise and minimizes the number of external elements at the same time.

### CLAIM OF PRIORITY

This application claims the benefit of Korean Patent Application No. 2005-53957 filed on Jun. 22, 2005, in the Korean Intellectual Property Office, the disclosure of which is incorporated herein by reference.

### BACKGROUND OF THE INVENTION

1. Field of the Invention

The present invention relates to a terrestrial Digital Multimedia Broadcasting (DMB) which can eliminate image noise and minimize the number of elements externally mounted.

2. Description of the Related Art

DMB stands for Digital Multimedia Broadcasting, which refers to a new concept of mobile multimedia broadcast service with broadcast and telecommunication merged together. The DMB service is divided into terrestrial DMB and satellite DMB depending on the transmission method and network configuration.

The terrestrial DMB executes mobile multimedia broadcast via VHF 12 channel (174-216 MHz) which is currently vacant as of 2004. One channel is broken down into three blocks and one block contains several video and audio signals. The compression method of the terrestrial DMB adopts MPEG4 technology and an electric wave thereof is characterized by diffraction, which is appropriate for long distance. The terrestrial DMB is currently being studied for its use inside the automobiles.

In order for a viewer to watch the terrestrial DMB broadcasted through the VHF 12 channel, a receiver is needed to receive and convert the corresponding frequency band of signals into intermediate frequency signals. This receiver will be referred to as a terrestrial DMB broadcast receiver throughout this specification.

FIG. 1 illustrates a conventional heterodyne type of terrestrial DMB receiver. The heterodyne type DMB receiver includes a bandpass filter 11 for passing only a signal in a specific frequency band while attenuating an outband signal from among the signals received at an antenna, a low noise amplifier 13 for amplifying the signal received from the bandpass filter with minimum noise, a Radio Frequency (RF) Auto Gain Controller (referred to as RF AGC hereinafter) 14 for adjusting the signal outputted from the low noise amplifier 13 to a predetermined magnitude, a Voltage-Controlled Oscillator (VCO) 16 for providing a local oscillating signal of a predetermined frequency to a mixer 15 which then mixes the output signal from the RF AGC 14 and the local oscillating signal into an IF signal, a Phase Locked Loop (PLL) 17 for adjusting the oscillating frequency of the oscillator 16, a SAW filter 19 for attenuating an outband signal from among the signals outputted from the mixer 15, and an AGC 18 for adjusting the magnitude of the signals outputted from the SAW filter 18.

The above described heterodyne type DMB receiver has high intermediate frequency such as 38.912 MHz and thus requires a SAW filter to be disposed in an intermediate frequency point. The SAW filter 19 cannot be disposed in an integrated circuit (IC) with other elements, due to its characteristics. In the conventional heterodyne receiver, the low noise amplifier 13, the RF AGC 14, the mixer 15, the oscillator 16, the PLL 17, and the IF auto gain controller (hereinafter referred to as IF AGC) 18 are integrated into a single IC 12, whereas the band pass filter 11 provided at the starting point and the SAW filter 18 are provided externally, connected from outside to the IC 12. Therefore, there is a drawback of increased number of external elements, resulting in a complicated structure for manufacturing process, which leads to great consumption of electricity.

On the other hand, another type is a terrestrial DMB receiver having a low IF structure as shown in FIG. 2. The low IF structure receiver, similar to the above description, includes a bandpass filter 21 for passing only a signal in a specific frequency band while attenuating an outband signal from among the signals received at an antenna, a low noise amplifier 23 for amplifying the signal received from the bandpass filter with minimum noise, a Radio Frequency (RF) Auto Gain Controller (referred to as RF AGC hereinafter) 24 for adjusting the signal outputted from the low noise amplifier 23 to a predetermined magnitude, an oscillator 26 for providing a local oscillating signal of a predetermined frequency to a mixer 25 which then mixes the output signal from the RF AGC 14 and the local oscillating signal into an IF signal, a Phase Locked Loop (PLL) 27 for adjusting the oscillating frequency of the oscillator 26, a low pass filter 28 for attenuating the outband IF signal from among the signals outputted from the mixer 25, and an IF AGC 29 for adjusting the IF signal outputted from the low pass filter 28 to a predetermined magnitude.

Such a low IF structure having the above constitution has a low intermediate frequency such as 2.048 MHZ, and thus a SAW filter is not required. Therefore, the low noise amplifier 23, the RF AGC 24, the mixer 25, the oscillator 26, the PLL 27, the low pass filter 28, and the IF AGC can all be integrated into a single IC. And the number of external elements is decreased, allowing easier manufacturing process. At the same time, however, image noise can occur with the low IF structure. A high Image Rejection Ratio (IRR) is required to eliminate the image noise but it is difficult to obtain such a high IRR with the low IF structure.

In the conventional heterodyne type, the image noise occurs in a higher frequency range, thus easy to be filtered. In addition, with the use of the SAW filter, the image noise cannot affect the desired signal. On the other hand, in the case of the low IF receiver, since the intermediate frequency signal has a low frequency range, the image noise occurs adjacent to the desired signal, and thus difficult to be filtered. Therefore, the low IF receiver adopts an Image Rejection (IR) mixer for the mixer 25. The capability to eliminate image noise by the IR mixer, represented by Image Rejection Ratio (IRR) is determined by gain mismatch and phase mismatch with an equation as the following.

$$IRR = \frac{{P}_{i m} ( output ) / {A}_{im}^{2} ( input )}{{P}_{sig} ( output ) / {A}_{sig}^{2} ( input )} ≅ \frac{{( Δ A / A )}^{2} + {θ}^{2}}{4} , if Δ A / A 〈 〈 1 , θ 〈 〈 1 rad$$

In the above equation, Pᵢₘ and Aᵢₘ are power and gain of image noise, respectively, whereas P_{sig} and A_{sig} are power and gain of desired signal. ΔA/A is gain mismatch of local oscillating signal and θ is phase mismatch of local oscillating signal.

In the current terrestrial DMB, the required Carrier to Noise Ratio (CNR) is 14 dBc. Therefore, as shown in FIG. 3, supposing that there are a Local Oscillating (LO) signal, a desired IF signal, and image noise (image signal), the attenuation ratio for satisfying the CNR of 14 dBc is as follows in Equation 1.

$$\begin{matrix}{CNR}_{AWGN + IM 3} = - 10 log [ {10}^{\frac{{CNR}_{AWGN}}{10}} + {10}^{\frac{{CNR}_{image}}{10}} ] \\ = - 10 log [ {10}^{\frac{14}{10}} + {10}^{\frac{{CNR}_{image}}{10}} ] \\ = 13.9 dB\end{matrix} \\ ⇒ {CNR}_{image} = 30.3277 dB \\ \begin{matrix}IRR = {CNR}_{image} + Δ P \\ = 30.277 + Δ P dB\end{matrix} \qquad Equation 1$$

Here, ΔP is the change, in the magnitude of the image signal due to the change in the environment, which is variable depending on the electric wave environment and the receiving environment, and which is in the range from about 10 dB to 30 dB in the case of the terrestrial DMB capable of receiving broadcast signals while on the move.

In light of the Equation 1, a maximum IRR of 60 dB is required from the low IF receiver, but the current IR mixer is not capable of achieving such level of IRR.

### SUMMARY OF THE INVENTION

The present invention has been made to solve the foregoing problems of the prior art and it is therefore an object of the present invention to provide a terrestrial DMB receiver capable of eliminating image noise while minimizing the number of external elements.

According to an aspect of the invention for realizing the object, there is provided a terrestrial DMB receiver including: a bandpass filter for passing a frequency signal in a terrestrial DMB channel band while attenuating an outband signal, from among signals received at an antenna; a low noise amplifier for amplifying the terrestrial DMB frequency signal passed through the band pass filter with minimum noise; a Radio Frequency Auto Gain Controller (RF AGC) for amplifying the signal outputted from the low noise amplifier into a predetermined magnitude; a down-converter for mixing the signal outputted from the RF AGC with a first local oscillating signal of the same frequency band into a baseband signal; a low pass filter for attenuating a high band noise signal from among the baseband signal outputted from the down converter; an up-converter for mixing the base band signal outputted from the low pass filter with a second local oscillating signal into a predetermined band of intermediate frequency signal; and an Intermediate Frequency Auto Gain Controller (IF AGC) for adjusting the intermediate frequency signal outputted from the up-converter to maintain a predetermined magnitude.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional terrestrial broadcast receiver;

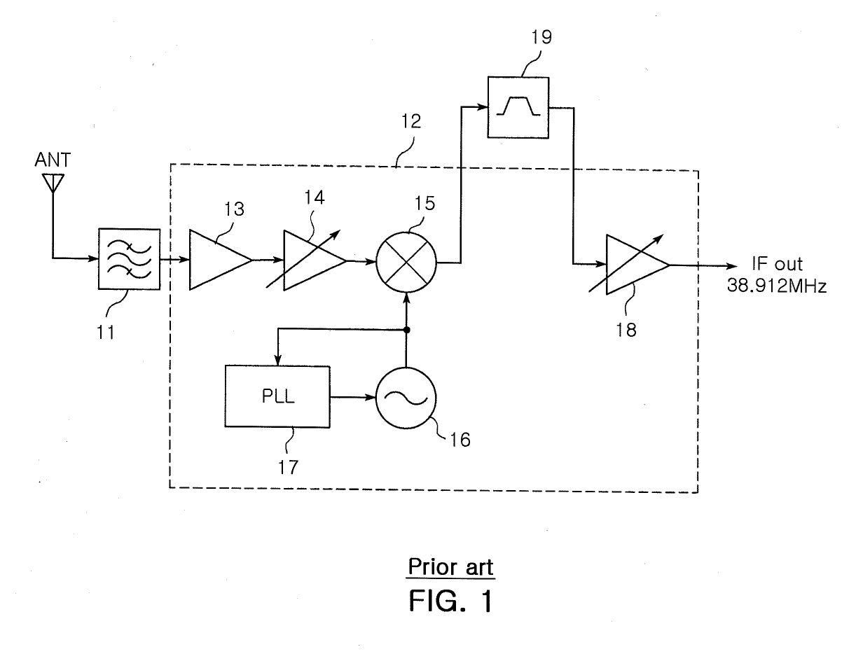

FIG. 2 is a block diagram illustrating another type of conventional terrestrial broadcast receiver;

FIG. 3 is a diagram illustrating signal requirement characteristics of a terrestrial DMB receiver;

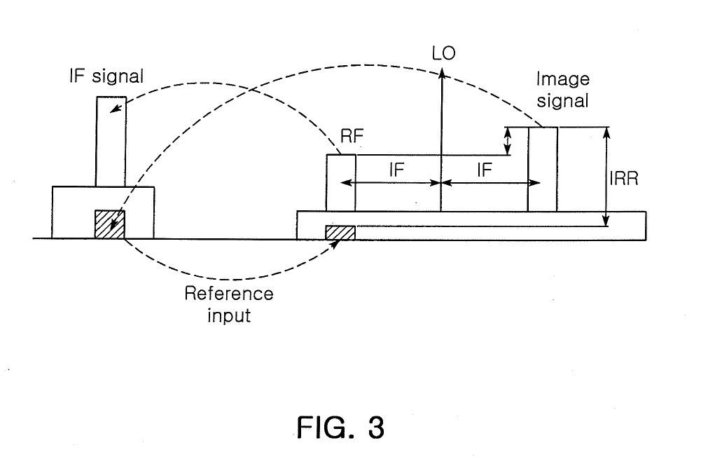

FIG. 4 is a block diagram illustrating a terrestrial DMB receiver according to the present invention; and

FIG. 5 is a block diagram illustrating in more detail a terrestrial DMB receiver according to the present invention.

### DETAILED DESCRIPTION OF THE PREFERRED EMBODIMENT

The following description will present constitution and operation of a terrestrial DMB receiver according to the present invention with reference to the accompanying drawings.

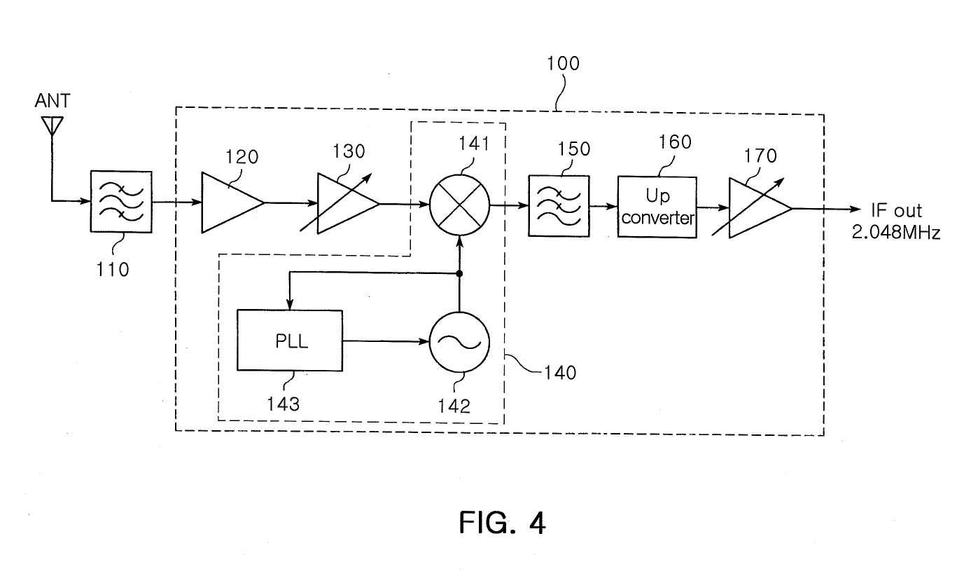

FIG. 4 is a block diagram illustrating functions of the terrestrial DMB receiver according to the present invention. With reference to FIG. 4, the terrestrial DMB receiver according to the present invention includes: a bandpass filter 110 for passing a frequency signal in a terrestrial DMB channel band while attenuating an outband signal, from among signals received at an antenna (ANT); a low noise amplifier 120 for amplifying the terrestrial DMB frequency signal passed through the bandpass filter 110 with minimum noise; a Radio Frequency Auto Gain Controller (RF AGC) 130 for amplifying the signal outputted from the low noise amplifier 120 into a predetermined magnitude; a down-converter 140 for mixing the signal outputted from the RF AGC with a first local oscillating signal of the same frequency band into a baseband signal; a low pass filter 150 for attenuating a high band noise signal from among the baseband signal outputted from the down converter 140; an up-converter 160 for mixing the base band signal outputted from the low pass filter 150 with a second local oscillating signal into an intermediate frequency signal of about 2.048 MHz; and an Intermediate Frequency Auto Gain Controller (IF AGC) 170 for adjusting the intermediate frequency signal outputted from the up-converter 160 to maintain a predetermined magnitude.

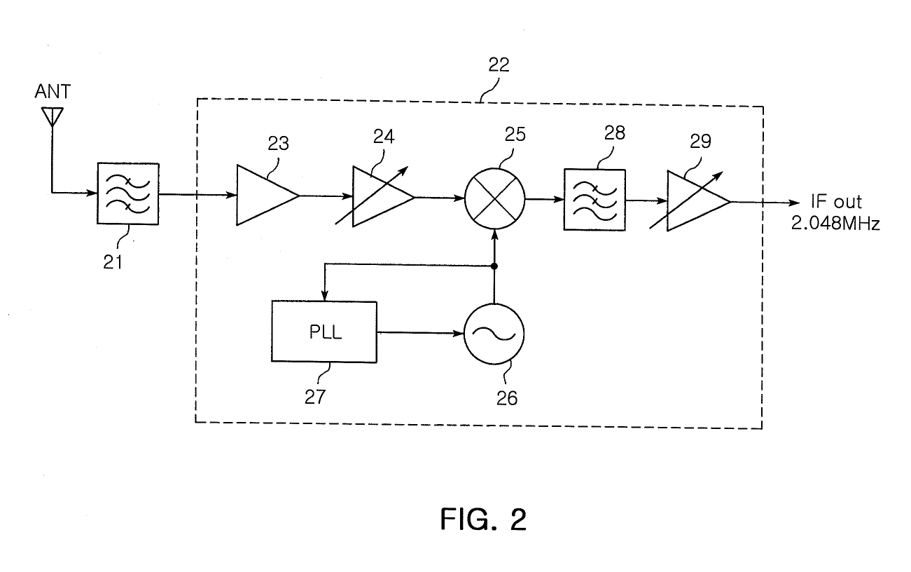

In the above described constitution, the band pass filter 110, the low noise amplifier 110, the RF AGC 130, and the IF AGC 170 are identical to those in the conventional low IF receiver as shown in FIG. 2.

The down-converter 140 is zero IF type of frequency-converting means which directly converts a radio frequency signal into a base band signal, and which includes a mixer 141 for mixing a received RF signal with a first local oscillating signal to output the resultant difference signal, a VCO 142 for providing the first oscillating signal having the same frequency band as the received RF signal to the mixer 141, and a Phase Locked Loop (PLL) 143 for adjusting the oscillating frequency of the VCO 142 according to a selected channel.

As the down-converter 140 directly converts the terrestrial DMB signal of the VHF 12 channel into a zero IF signal, i.e. a baseband signal from which a carrier wave is removed, there is no need to take the effect of the image noise into consideration. In addition, because the output signal of the down-converter 140 is a low frequency baseband signal, it can be filtered by a general low pass filter. As a result, use of a SAW filter is inhibited and the number of external elements can be reduced.

Subsequently, the baseband signal is up-converted and outputted into a signal of an intermediate frequency band required by the user, i.e. 2.048 MHz, via an up-converter 16, thus meeting the needs of the user.

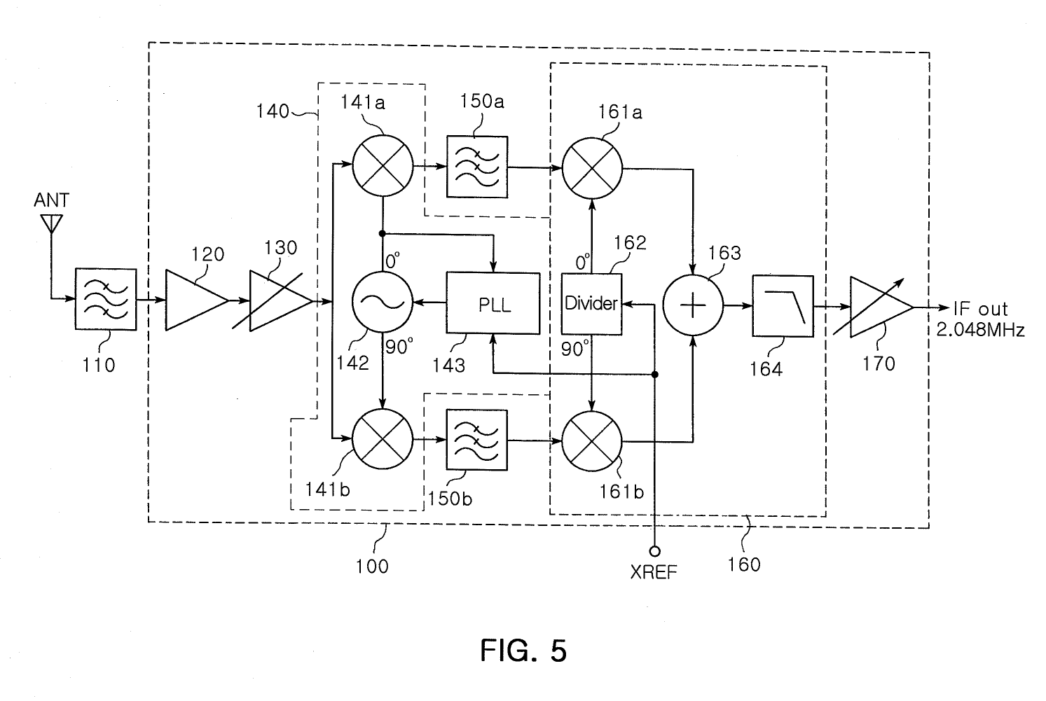

FIG. 5 is a more detailed block diagram of the terrestrial DMB receiver according to the present invention, including detailed configurations of the down-converter 140 and the up-converter 160.

Referring to FIG. 5, in the terrestrial DMB receiver according to the present invention, the down-converter 140 includes: a VCO 142 for providing the first local oscillating signal, with a phase difference of 90 degrees, to first and second down-conversion mixers 141a and 141b, the first local oscillating signal having a frequency equal to that of the selected channel; the first and second down-conversion mixers 141a and 141b for mixing the RF signal received from the RF AGC 130 with the first local oscillating signal into a baseband I/Q signal; and a Phase Locked Loop (PLL) 143 for adjusting the oscillating frequency of the VCO 142 so that the VCO 142 compares the first oscillating signal with a reference signal (XREF) to make the phase and/or frequency difference equal to 0.

The low pass filter 150 includes first and second low pass filters 150a and 150b, connected to the first and second down-conversion mixers 141a and 141b, respectively, to filter the baseband I/Q signal.

The up-converter 160 includes: first and second up-conversion mixers 161a and 161b for mixing the baseband I/Q signal outputted from the first and second low pass filters 150a and 150b with a second local oscillating signal into an intermediate frequency I/Q signal; a divider 162 for dividing a reference signal (XREF) to provide the second local oscillating signal having a frequency equal to a predetermined intermediate frequency to the first and second up-conversion mixers 161a and 161b; an adder 163 for adding the intermediate frequency I/Q signal outputted from the first up-conversion mixer 161a with that outputted from the second up-conversion filter 161b; and a low pass filter 164 for filtering the intermediate frequency I/Q signal outputted from the adder 163 and providing the filtered intermediate frequency I/Q signal to the IF AGC 170.

The first oscillating signals provided to the first down-conversion mixer 141a and the second down-conversion mixer 141b from the oscillator 142 have a phase difference of 90 degrees but the same frequency value corresponding to the carrier wave of the selected channel. In the same manner, the second oscillating signals provided to the first up-conversion mixer 161a and the second up-conversion mixer 161b also have a phase difference of 90 degrees but the same frequency value corresponding to a central frequency of a predetermined intermediate frequency band.

With reference to FIG. 5, the operation of the terrestrial DMB receiver according to the present invention is as follows.

A terrestrial DMB signal passed through the VHF channel 12 of 174-216 MHz is received at the antenna to pass through the bandpass filter 110. At this time, an outband signal having a frequency outside the range of the VHF 12 channel is attenuated. The weak terrestrial DMB signal that passed through the band pass filter 110 is amplified into a predetermined magnitude at the low noise amplifier 120. The low noise amplifier 120 is an amplifier which is designed to lower Noise Factor (NF) by setting operating point and matching point at a certain value, and generally used for a receiver.

The terrestrial DMB signal amplified at the low noise amplifier 120 is level-adjusted to a predetermined magnitude at the RF AGC 130. The RF AGC 130 is a means for adjusting the DMB signal to a certain range of magnitude so as to prevent distortion or saturation in the subsequent process such as frequency-conversion.

The terrestrial DMB signal adjusted in magnitude at the RF AGC 130 is simultaneously inputted to the first and second down-conversion mixers 141a and 141b of the down-converter 140. The first and second down-conversion mixers 141a and 141b are each provided with first local oscillating signals with a phase difference of 90 degrees but the same frequency as the selected DMB channel. Therefore, the first and second down-conversion mixers 141a and 141b mix the received terrestrial DMB signal with the first local oscillating signal and frequency-convert them into baseband I/Q signals corresponding to the difference between the signals.

The I/Q signals outputted from the first and second down-conversion mixers 141a and 141b are respectively inputted into the low pass filters 150a and 150b to be filtered to attenuate noise, and then inputted to first and second up-conversion mixers 161a and 161b of the up-converter 160. The first and second up-conversion mixers 161a and 161b are each inputted with second local oscillating signals from the divider 162 which divides a reference signal XREF. The second local oscillating signals are set to have a central frequency of the predetermined intermediate frequency band. Here, the intermediate frequency is set to be 2.048 MHz.

Therefore, the first and second up-conversion mixers 161a and 161b each mix the received baseband I/Q signal with the second local oscillating signal of 2.048 MHz to output an intermediate frequency I/Q signal of 2.048 MHz corresponding to the sum of the signals.

The intermediate frequency I/Q signals outputted from the first and second up-conversion mixers 161a and 161b are summed up into one at an adder 163 to be filtered at the low pass filter 164, and subsequently inputted into the IF AGC 170. The intermediate frequency I/Q signals are adjusted to a predetermined magnitude at the IF AGC so as to prevent saturation or demodulation distortion such as in a demodulation process afterwards.

According to the operation described above, the down-converter 140 directly converts a received terrestrial DMB signal into a zero IF signal, solving the problematic image noise. Subsequently, the up-converter 160 up-converts the zero IF signal into an intermediate frequency signal required by the user, thus meeting the needs of the user.

In addition, as the use of a SAW filter is unnecessary, the low noise amplifier 120, the RF AGC 130, the down-converter 140, the low pass filter 150, the up-converter 160, and the IF AGC 170 can all be integrated into a single IC, resulting in the minimum number of external elements.

In the present invention as set forth above, the terrestrial DMB receiver can satisfy the needs of the users while eliminating image noise and minimizing the number of external elements.

While the present invention has been shown and described in connection with the preferred embodiments, it will be apparent to those skilled in the art that modifications and variations can be made without departing from the spirit and scope of the invention as defined by the appended claims.

What is claimed is:

1. A terrestrial Digital Multimedia Broadcast (DMB) receiver comprising:
a bandpass filter for passing a frequency signal in a terrestrial DMB channel band while attenuating an outband signal, from among signals received at an antenna;
a low noise amplifier for amplifying the terrestrial DMB frequency signal passed through the band pass filter with minimum noise;
a Radio Frequency Auto Gain Controller (RF AGC) for amplifying the signal outputted from the low noise amplifier into a predetermined magnitude;
a down-converter for mixing the signal outputted from the RF AGC with a first local oscillating signal of the same frequency band into a baseband signal;
a low pass filter for attenuating a high band noise signal from among the baseband signal outputted from the down converter;
an up-converter for mixing the base band signal outputted from the low pass filter with a second local oscillating signal into a predetermined band of intermediate frequency signal; and
an Intermediate Frequency Auto Gain Controller (IF AGC) for adjusting the intermediate frequency signal outputted from the up-converter to maintain a predetermined magnitude.

2. The terrestrial DMB receiver according to claim 1, wherein the IF signal is set to be 2.048 MHz.

3. The terrestrial DMB receiver according to claim 1, wherein the down-converter comprises:
an oscillator for providing the first local oscillating signal, with a phase difference of 90 degrees, to first and second down-conversion mixers, the first local oscillating signal having a frequency equal to that of a carrier wave of the terrestrial DMB;
the first and second down-conversion mixers for mixing the RF signal received from the RF AGC with the first local oscillating signal into a baseband I/Q signal; and
a Phase Locked Loop (PLL) for controlling the oscillator to compare the first oscillating signal with a reference signal to output the first local oscillating signal at a predetermined frequency.

4. The terrestrial DMB receiver according to claim 3, wherein the low pass filter comprises first and second low pass filters, connected to the first and second down-conversion mixers, respectively, to filter the baseband I/Q signal.

5. The DMB receiver according to claim 4, wherein the up-converter comprises:
first and second up-conversion mixers for mixing the baseband I/Q signal outputted from the first and second low pass filters with the second local oscillating signal into an intermediate frequency I/Q signal;
a divider for dividing a reference signal to provide the second local oscillating signal with a phase difference of 90 degrees to the first and second up-conversion mixers, the second local oscillating signal having a frequency equal to a predetermined intermediate frequency;
an adder for adding the intermediate frequency I/Q signal outputted from the first up-conversion mixer with that outputted from the second up-conversion filter; and
a low pass filter for filtering the intermediate frequency I/Q signal outputted from the adder and providing the filtered intermediate frequency I/Q signal to the IF AGC.

6. The terrestrial DMB receiver according to claim 1, wherein the low noise amplifier, the RF AGC, the down-converter, the low pass filter, the up-converter, and the IF AGC are integrated into a single chip.
